(19) United States
(12) Patent Application Publication
(10) Pub. No.: US 2005/0243181 A1
(43) Pub. Date: Nov. 3, 2005

(54) Device and method of detection of erroneous image sample data of defective image samples

(75) Inventors: Cristiano Castello, Eindhoven (NL); Parikshit Kumar, Eindhoven (NL); Alouisius Wilhelmus Marinus Korthout, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/519,052

(22) PCT Filed: Jun. 23, 2003
(86) PCT No.: PCT/IB03/02940

§ 371 Date: Dec. 22, 2004

(30) Foreign Application Priority Data
Jul. 1, 2002 (EP) 02077605.0

(51) Int. Cl. H04N 5/228

(52) U.S. Cl. 348/222.1

(57) ABSTRACT

A real-time pixel correction algorithm is proposed for on-the-fly repair of pixel information from dead or disturbed pixels from a pixel array. The algorithm can be used for both CCD and CMOS imagers.

The invention relates to a method of detection of erroneous image sample data from a plurality of image sample data. Also the invention relates to a method of image processing wherein an image is provided by an optical system to an image color sensor, which is adapted to detect various colors and sensor the image as a plurality of image samples, and wherein image sample data are read out from each single image sample of the image sensor, and the image sample data comprise color information, and are transferred in an image signal from the image sensor to a signal processor, and the signal processor derives a video output from the image signal, wherein erroneous image sample data of defective image samples are detected and corrected from the plurality of image sample data, and wherein an image sample data is tested to thereby detect erroneous image sample data and an erroneous image sample data is corrected by replacing an erroneous image sample data by a corrected image sample data. Further, the invention relates to a processor device, an imager system and a program product for a computing system.

In modern solid-state cameras a variety of photoelectric image sensors may be used. Such an image sensor may be e.g. a detector based on a charge transfer imager, a charge coupled device (CCD), a bucket-brigade imager, a charge injection device (CD) or a CMOS-imager.

Such photoelectric image sensors, preferably a CMOS imager or a charge transfer imager, are conventionally fabricated by integrated circuit techniques and basically constitute an array of discrete elements referred to as a pixel or an image sample, which are capable of sampling an image by a plurality of discrete image samples. A CMOS imager may be used in general. However, using an imager of the charge transfer type can bring some advantages in noise performance. The image sensor can be read out for each image sample, providing an analog signal comprising image sample data for each image sample. The analog signal may also be converted to a digital signal comprising image sample data for each image sample. Such digital signal is advantageously further processed by further digital signal processing (DSP).

Once a discrete element, pixel or image sample of an above-mentioned charge transfer device is defective; this results in erroneous image sample data of the defective image sample. As a consequence this may result in observable spots or lines in an image reproduced by the above-mentioned photoelectric image sensors.

Conventional methods try to remove erroneous image sample data of defective image samples by analyzing an image, storing the location of a defective element of the photoelectric image sensor and subsequently correcting those erroneous image sample data assigned to the defective image sample as recorded and stored in a memory. The conventional methods may therefore be regarded as methods which are merely capable to perform image sample data correction in an off-line processing using some kind of previously recorded information or calibration stored in a memory. As a defective state of an image sample of a photoelectric image sensor may depend on various circumstances of use e.g. temperature, voltage or the use of adjacent image samples, the above-mentioned conventional method of recording a location of a defective image sample or some kind of calibration is not reliable.

Further, such conventional method is based on a memory and intermediate recording of erroneous image sample data, which may result in a loss of processing performance. In general coordinate based pixel correction algorithms work with dedicated hardware designed for it. This means that in general no micro-processor is used for this, but the correction algorithm usually is part of a DSP function or module performing the digital signal processing. Thereby still a loss of processing performance results due to conventional methods.

In the EP 1 003 332 A2 a method of correcting defects in an electronic imaging system is proposed which relies on the use of a defect-memory. Such use of a memory for the intermediate recording of image sample data or storing of defective image sample locations may result in substantial loss of processing performance and may not be used in real-time applications.

In the U.S. Pat. No. 4,253,120 a defect-detection system comprising a charge transfer imager is proposed in which a serial output signal of a charge transfer imager is processed by a signal processing means, which includes a defect-detection means for indicating as spurious each single picture sample of a serial output signal that exhibits certain contrast characteristics with respect to its neighboring picture samples. This permits a spurious sample to be corrected by an interpolated value derived from its neighboring samples. The teaching of U.S. Pat. No. 4,253,120 is directed to a low-cost solution of an imager, which is capable of real-time detection of spurious signals produced by defective elements of an imager during actual use of a solid state camera employing the imager.

However, the above-proposed scheme for the detection of erroneous image sample data of defective image samples relies on simple contrast characteristics, which are typically merely well suited to black/white-imagers. All pixels of such imagers are considered in the same way, in the sense that no distinction is made whether or not a pixel has a certain color. The teaching of U.S. Pat. No. 4,253,120 suggests to indicate as spurious any single picture sample having an actual value which falls outside of a range of probable interpolated values for that single picture sample. Said range of probable interpolated values is determined from said respective values of neighboring picture samples for that single picture sample. This approach is applied to provide the above mentioned certain contrast characteristics. However, the interpolation is performed regardless of the color of a pixel. The teaching of U.S. Pat. No. 4,253,120 therefore is not applicable to color-sensors or color-imagers, as color imagers provide different color planes of different characteristics in luminance, color, contour and contrast.

If an image comprising various different colors would be processed according to the teaching of U.S. Pat. No. 4,253,120 even pixels of different color would be considered in the same way and this consequently would result in a processed image of only poor quality.

This is where the invention comes in, the object of which is to provide a method of detection of erroneous image sample data of defective image samples and a method of image processing, further to provide a processor device, an image system and a program product adapted to improve image processing for image sample data comprising color information. In particular, real-time image processing of image sample data of a color sensor, specifically of a RGB-Bayer image sensor, should be enabled in an effective way.

As regards the method the object is achieved by a method of detection of erroneous image sample data as mentioned in the introduction, wherein according to the invention the plurality of image sample data comprises a first number of image sample data assigned to a first color and at least a second number of image sample data assigned to a second color, wherein an image sample data under test is tested with respect to further image sample data and
a first kind of test is performed with respect to a further image sample data assigned to the same color as that to which the image sample data under test is assigned; and
a second kind of test is performed with respect to still a further image sample data assigned to a different color than that color to which the image sample data under test is assigned.

In a most preferred configuration the image sample data under test in a first step is compared to a threshold value. In particular a threshold value is a maximum value of noise level. If the image sample data is below this level the respective image sample is not considered as defective and the image sample data are considered as something in the black level, which should not be disturbed as otherwise there would be prominent smearing of the image in black. The image sample data may be provided as a signal voltage which is tested in the threshold test as to whether it has a meaning or not.

In a preferred configuration a plausibility test may be performed as a third kind of test, in particular, a plausibility test taking into consideration previous and/or subsequent tests. In particular the third kind of test may take into consideration information of image sample data from a previous line of image samples of a charge transfer device array. Most preferably it may be checked if there is any correction in either the previous line of the same column or the column before that or in the column after the column under test.

An image sample corresponds in general to a discrete element of an array of a photoelectric image sensor, like a charge transfer device or a CMOS imager. Such discrete element is generally referred to as a pixel. Correspondingly, an image sample data comprises a pixel value, in particular a signal voltage value.

The invention has arisen from the desire to provide a suitable method and apparatus of image processing of image data from a color image sensor, in particular an RGB-sensor. In an array of pixels being part of a color sensor, in particular of a RGB-Bayer sensor, each pixel is assigned to a specific color and is arranged to sense in particular the specific color. In an RGB-Bayer sensor a first kind of pixels is assigned to the green color, a second kind of pixels to the red color and a third kind of pixels to the blue color. The pixels of each color are arranged with regard to a specific pattern of a respective color in the array. The smallest 2×2 array of pixels in a RGB-Bayer sensor comprises two green-pixels, one red-pixel and one blue-pixel. The plurality of pixels of a pattern of pixels of a specific color is also referred to as a color plane. Images comprising different color planes comprise image sample data in each color plane. Therefore, the main idea is to provide various possibilities for the handling of image sample data assigned to various different color planes. For processing, the image sample data of each color plane are provided separately due to a spatial filter, which is sensitive to the pattern of pixels of each color respectively. A spatial filter included in the method makes use of a color filter pattern of a color sensor in use. The invention has realized that a method of detection of erroneous image sample data of a color sensor can be significantly improved by performing tests with respect to a first and second color plane.

The modulation transfer function, of which gives the spatial frequency response of the optical system, the image sensor or other imaging related devices, cannot eliminate a single pixel. Consequently even a small or thin feature which is part of the image and which is not due to a defect pixel should be present in different color planes. Therefore tests with regard to different color planes provide a simple and reliable measure for discriminating between true features of a colored image and defect pixels. Although all data from different color planes are preferably treated the same and there is preferably no color-plane dependent check or setting, conditions may be derived from further image sample data of the same color plane or a further different color plane. Regarding the latter, if necessary, also a correlation of further image sample data of the same or other color planes may also be accounted for. If the first kind of test performed in a first color plane indicates erroneous data, the second kind of test is advantageously performed as a consistency check in a second color plane. This makes the proposed method particular reliable. Also this allows image processing of image sample data of color sensors to be effectively achieved. In particular, such a scheme is preferably optimized for RGB-imagers with regard to real-time-processing.

The most important advantage of the development of this on-the-fly defect pixel detection and correction method are:
solving the costly calibration cycle in the production line when a coordinate based algorithm is used.
The amount of defect pixels and the locations is not 100% stable. Sometimes a new defect pixel appears and sometimes an existing defect pixel disappears. Even in this the proposed method achieves reliable results.
There is no need for additional memory support for storing defect pixels.
   Such advantages may even be improved by continuously developed configurations as further outlined in the dependent method claims.

In a preferred configuration still further tests comprise at least one test selected from the group consisting of: nearest-neighbor-comparison, second-nearest-neighbor-comparison and further-neighbor-comparison. In general an image sample data under test may be tested with regard to its nearest neighbors, those being the horizontal, vertical and/or diagonal adjacent neighbors of an image sample data under test. A further test may be performed with regard to the second-nearest-neighbors, those being further image sample data adjacent to the nearest neighbor image sample data. Further neighbor-testing with regard to testing of further image sample data of a higher correlation within the hierarchy of neighbors may also be performed.

Such testing may in particular be a comparison of an image sample data under test with a further image sample data.

Also such tests may comprise tests merely between further image sample data of a color different to that of the image sample data under test. Such testing is performed to most advantage within one color plane of image sample data i.e. image sample data assigned to the same color are tested. Further image sample data may be tested within the same but different color plane. This color plane may be different than that to which the image sample data under test is assigned. Furthermore, image sample data of different color planes may be tested in combination with image sample data under test.

In a continuously developed configuration at least one test e.g. the threshold test or any one of a number of the neighbor-tests, i.e. at least tests of the first or the second kind, take in consideration a noise level correction. Such noise level correction may comprise a correction regarding an offset. Further such correction may comprise factor corrections. Specifically, an image sample data may be reduced by a noise offset and multiplied with a factor that takes into consideration a photon shot noise. Such noise level correction is advantageously adapted with regard to each color plane. Specifically, it is advantageous that a noise level correction is applied to each respective color plane, in particular with regard to an offset and/or a factor.

In a preferred configuration a test is essentially based on a one-dimensional-neighbor comparison in a two-dimensional image sample data array. Such measures enhance signal processing times and allow for real-time-performance. The use of a defect-memory is thereby advantageously avoided. Moreover, anyone of the tests, in particular the first kind of tests, may be advantageously based on a maximum value comparison.

Nevertheless, two-dimensional tests and comparisons other than the maximum-value-comparison e.g. a mean-value-comparison may be performed if appropriate.

In a further developed configuration the above-mentioned parameters of the proposed method, such as offset, threshold and variance, may be derived by arranging a plurality of image sample data in a stack. The threshold may be defined as the sum of the variance and the offset.

A preferred configuration comprises a comparison of a difference-value of at least two image sample data with respect to the variance. Further varied variance values may be defined for the variance with respect to a variety of modes of a camera. In particular a first variance value with respect to a snapshot mode and a second variance value with respect to a video mode may be defined.

Advantageously a color parameter e.g. taking into consideration a noise level, is applied to discriminate between a test with respect to image sample data assigned to the same color and a test with respect to image sample data assigned to different colors or a different color plane.

Further as regards the method the object is achieved by a method of image processing as mentioned in the introduction, wherein in accordance with the invention the plurality of image sample data comprise a first number of image sample data assigned to a first color and at least a second number of image sample data assigned to a second color and wherein for an image sample data under test the detection comprises the steps of:
comparing the image sample data under test to a threshold value,
performing a first kind of test with respect to further image sample data assigned to the same color as that to which the image sample data under test is assigned,
performing a second kind of test with respect to still a further image sample data assigned to a different color than that to which the color the image sample data under test is assigned,
performing a plausibility test as a third kind of test, taking into consideration a previous and/or subsequent test of still further image sample data.

Continuously developed configurations are further outlined in the dependent method claims.

With regard to the correction of erroneous image sample data, such data may be replaced by corrected image sample data where the correction comprises an interpolation.

In particular for detection and correction a shift register, a threshold calculation and a memory may be provided. Most preferably a one-bit-line-memory or a two-bit-line-memory is provided. Such methods will enhance single processing. The read-out from the image sensor may be most preferably a serial read-out.

The methods proposed are applied most advantageously to an RGB-Bayer-sensor.

As regards the object of a processor device the invention leads to a processor device for deriving a video output from an image signal comprising a memory, a processing unit and an interface, in particular an interface that can be connected to an image sensor and an interface that can be connected to a monitor, which is adapted to implement a method of detection such as that proposed above.

The invention also leads to an imager system comprising an optical system, a photoelectric image sensor and a processor device adapted to implement a method such as that proposed above. In particular, such image system may comprise a CMOS or CCD or CID image sensor, in particular a RGB-Bayer sensor.

In particular the invention leads to a program product for a computing system, which can be stored on a medium that can be read out by a computing system comprising a software code section which induces the computing system to execute the method of detection as proposed when the product is executed on the computing system. In particular the product may be executed on a processor device or an image system as proposed. A preferred algorithm will be indicated in the detailed description.

The invention will now be described in detail with reference to the accompanying drawing. The detailed description will illustrate and describe what is considered as a preferred embodiment of the invention. It is of course being understood that various modifications and changes in form or detail could readily be made without departing from the spirit of the invention. It is therefore intended that the invention may not be limited to the exact form and detail shown and described herein, nor to anything less than the whole of the invention disclosed herein and as claimed hereinafter. Further, the features described in the description, the drawings and the claims disclosing the invention, may be essential for the invention taken alone or in combination.

The figures of the drawing illustrate:

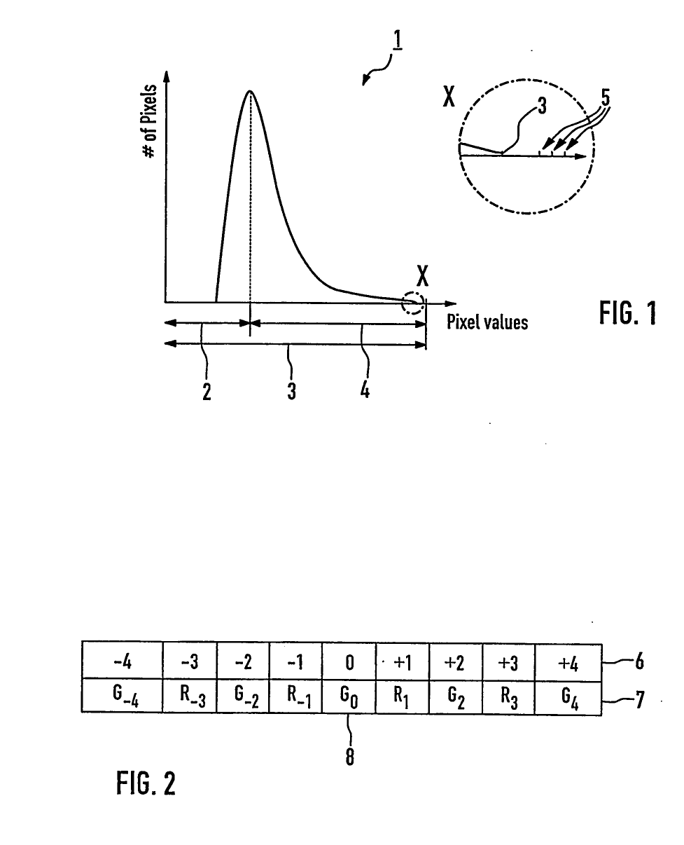

FIG. 1 a stack of black column pixel values in descending order;

FIG. 2 a column under test;

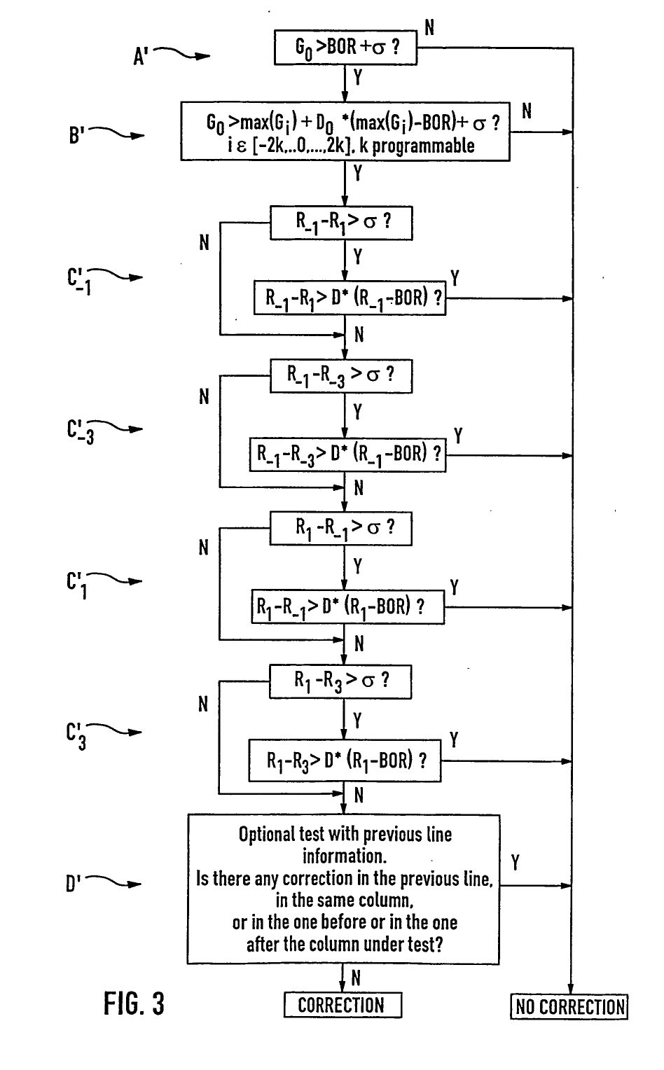

FIG. 3 a flowchart of a preferred embodiment of a method of detection of erroneous image sample data of defective samples;

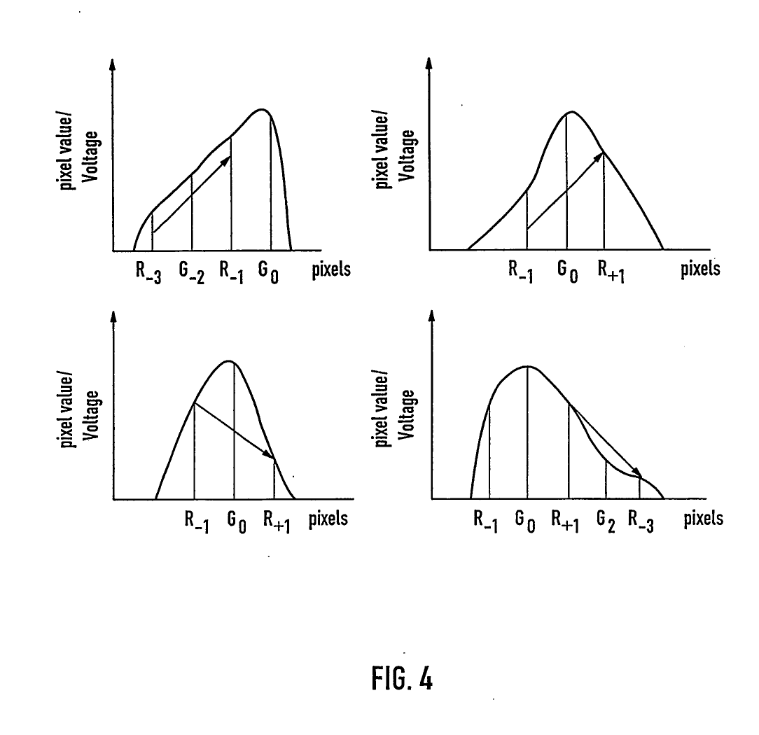

FIG. 4 an example showing that if Rᵢ−Rⱼ>σ, than Rᵢ and Rⱼ are both below a black offset register level as mentioned in FIG. 3;

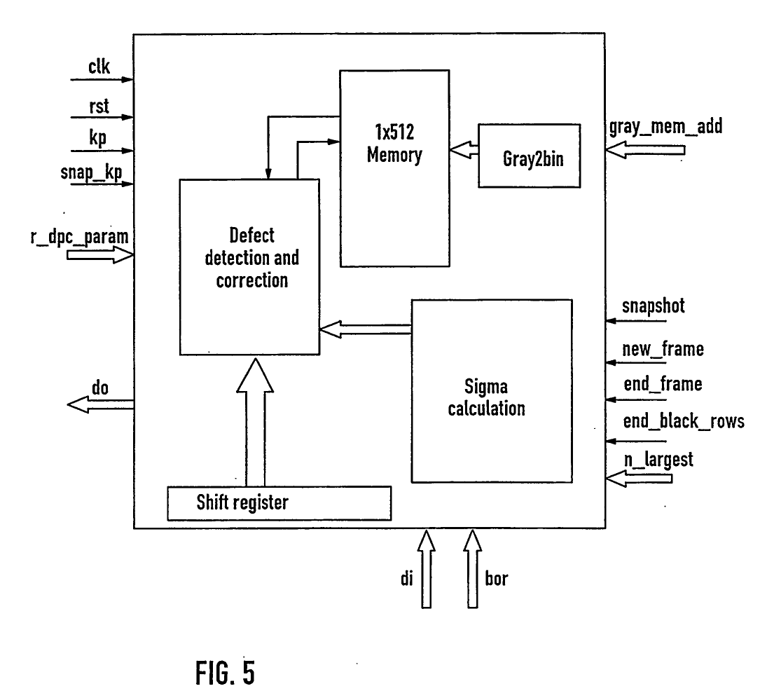

FIG. 5 design specification of a preferred embodiment of a processor device or a signal processor.

In the proposed method of signal processing most importance is applied to the detection phase as opposed to the correction phase to avoid disturbing the image information in good pixels. Moreover, it is preferable that no dead pixels in the sensor have to be corrected, i.e. only positive deviators have to be corrected. Also advantageously there are no clusters of defective pixels to be corrected. If there should be any dead pixels or a cluster of defective pixels such defects are handled by additional measures, which are quickly and effectively established and also account for real-time processing needs. Such schemes are also applicable for CMOS-sensors.

The preferred embodiment may be divided into a phase of defect-detection and a phase of defect-correction. For defect-detection in particular it is preferable that a σ variance calculation is performed to properly and advantageously take into consideration different color planes of image sample data.

With respect to the defect-detection a stack of image sample data, i.e. values of pixels are first provided. In the preferred embodiment a search is made in all the black columns, or possibly rows, or at least one of them, in the snapshot mode for a first few largest values of pixels. As shown in FIG. 1 these values are arranged in stack 1 in descending order. Some of these values could be due to leaking pixels 5 (inset of FIG. 1) but the rest of them will be quite close to the maximum value of noise level 3 referred to as threshold 3. Further, a black offset register level (BOR) may be defined as an offset 2 and could be user programmed. So the difference between threshold 3 and offset 2 (black offset register level, BOR) gives a good estimate of the distribution of noise 4. The distribution of noise 4 is referred to as a pseudo variance or. The level in stack 1 is to be chosen for the distribution of noise (σ) 4 and can be programmable.

Detailed design and timings will be illustrated further in the following.

In FIG. 2 a number of pixels, which may be arranged in either a row or a column, are illustrated with their number in the first line 6 of FIG. 2 and their reference name in the second line 7 of FIG. 2. The pixels assigned to a green color are referred to as G-pixels, those assigned to a red color are referred to as R-pixels and further (not shown) pixels assigned to a blue color could be referred to as B-pixels. The pixel 8 under test is referred to as G₀.

A preferred embodiment is illustrated in a flowchart of FIG. 3, which may also describe a flowchart of a respective algorithm for a program product for a computing system.

The flowchart illustrates the four parts A′, B′, C′ and D′ of the preferred method embodiment.

In the first part A′ a test is performed, to establish if the signal is above the black offset register level (BOR=2) corrected with a noise pseudo variance (σ=3). The first check is to establish if the signal (i.e. the voltage of an image sample data under consideration) has a meaning or not In particular, if the signal is below the black noise level (BOR), a correction is not necessary and the pixel is not considered as defective. An exit is made because something in the black level is being taken in consideration, which should not be disturbed, otherwise there would be prominent smearing of the image in black.

In a second part B′ a test is performed to establish if the pixel under test has a higher value than its neighbors of the same color plane. If it is smaller then an exit is made because this means that it fits in well with the environment. In this step also the photon shot noise (D₀*(max(Gᵢ)−BOR)) and additionally the total noise 4 in black (a) are taken into consideration (D₀*(max(Gᵢ)−BOR)+σ)). It is to be noted that the BOR level 2 is used to shift the signal video and so, if one is to avail oneself of a percentage of a signal, one has to refer to the BOR level 2 and not to zero. This is the reason why “max(Gᵢ)−BOR” is used. Experimental results show an advantageous value of D₀ as being 12.5%. In some conditions, which may depend on the gain and the properties of the light censored by the imager, a smaller value of D₀ may give even better results. For this reason a further programmable value of 6.25% is offered.

In a third part referred to as C′, in particular C′₋₁, C′₋₃, C′₁ and C′₃, a test is performed to establish if the pixel under test G₀ has a higher value than its neighbors in the same color plane and if there is any step transition among the neighbors of the different color plane.

If a pixel under test corresponds to a thin line (or a small feature) and is not a defect, then it is quite possible that some of the light from a scene may be directed onto its immediate neighbors in a different color plane and may thereby cause a step transition.

If such a step transition is found in the other color plane then the pixel should not be detected as a defect. To take this decision the difference between the signals should exceed the noise 4 (σ). This is tested by “Rᵢ−Rⱼ>σ” in FIG. 3. The indices i, j may take the values of 1, −1, 3 or −3 as shown in FIGS. 3 and 4.

With reference to FIG. 4 it is to be noted that, with regard to the way in which the noise 4 (σ) is calculated, it amounts in general to a value between three and six times the real variance of the noise. Therefore it is impossible that if Rᵢ−Rⱼ>σ both, Rᵢ and Rⱼ, amount to a value below the black offset register level 2 (BOR), as outlined in FIG. 1. An example of this is illustrated in FIG. 4. In each case outlined in FIG. 4 at least one of the values of Rᵢ, Rⱼ, exceeds the black offset register level 2 (BOR). The difference value of Rᵢ−Rⱼ is indicated by an arrow.

FIG. 5 illustrates a design specification of a preferred embodiment of the apparatus of a processor device or a signal processor, wherein the design specification comprises the σ-calculation as illustrated in FIG. 1.

As shown in FIG. 5 a defect will be corrected once it has been detected. Such correction may preferably be performed by replacing a defective image sample data with an interpolated image sample data. Such interpolation may consider neighbors in a one-dimensional interpolation of an array. Nevertheless a two-dimensional interpolation may also be advantageous.

Further, a shift register and an intermediate memory may be provided, preferably of the size 1×512.

In the following the σ-calculation will be described in detail with reference to FIG. 5.

In principle there are two modes of operation for a sensor, which are (1) snapshot mode or (2) video mode. For both modes a specific timing wave form and specific σᵢ (i=1, 2) is provided. For the snapshot mode a σ₁-value may be provided. For the video mode a σ₂-value may be provided.

A bit “snapshot” is used to distinguish between the two modes:
Snapshot=1->snapshot mode,
Snapshot=0->video mode.

The position in the stack to be used as threshold level is specified by a 3-bit register “N_largest”.

In the snapshot mode the availability of black pixels is detected by an input pulse “snap_kp”:
snap_kp=1->input data is to be used for σ-calculation,
snap_kp=0->input data are not to be used for σ-calculation.

In the video mode the input “kp” serves the same purpose as “snap_kp” in the snapshot mode. Inputs “clk” and “rst” concern a clock and a reset respectively. Further inputs “rdpc_param”, “gray mem_add”, “di” and “bor” are provided and a further output “do”.

“Snapshot” and “N_largest” are programmed in a Control Register:

| | | | | | | | |
|---|---|---|---|---|---|---|---|
| RECOFF | REOCRS | SNAPSHOT | N_largest 2 | N_largest 1 | N-largest 0 | — | — |

In the snapshot mode the σ₁-value should be available before the active pixels are read, whereas in the video mode the σ₂-value is calculated at the end of one frame and is used in the next frame. In both modes the stack is reset at the beginning of every new frame as shown in FIG. 1. Thus, three inputs are required for the correct updating and calculation of σ₁:
1. new_frame=1->resets the stack
2. end_frame=1->marks the end of a frame and is used to update σ in the video mode
3. end_black_rows=1->marks the end of black rows in the snapshot mode

The signals “end_frame” and “end_black_rows” are mutually exclusively generated in one specific mode of operation only.

In the snapshot mode the beginning and end of black rows to be used for σ₁ are specified by two 3-bit registers “Srow” (starting row) and “Erow” (end row), both of which can be included in a single register:

| | | | | | | | |
|---|---|---|---|---|---|---|---|
| — | — | Erow2 | Erow1 | Erow0 | Srow2 | Srow1 | Srow0 |

In the design specification of FIG. 5 the defective pixel detection and correction is adapted as follows. To give more flexibility to the defective pixel detection, several programmable options are included in the following byte:

| | | | | | | | |
|---|---|---|---|---|---|---|---|
| — | Cor_avg | NumNei | D_{1.2} | D_{1.1} | D₀ | EnMem | Encor |

“NumNei” (number of neighbors) defines the number of neighbors to be taken into account to perform the neighbor test B′ of the same color plane:

| | |
|---|---|
| Values of “NumNei”: | 0 → 2 neighbors to the left and 2 to the right |
| | 1 → 3 neighbors to the left and 3 to the right |
| Default value of | 0 |
| “NumNei”: | |

D_{1.2}, D_{1.1} are used to have different values of D as outlined above for a different color plane, i.e. different size of steps. As an example several values of D_{1.2}, D_{1.1} are shown in the following table:

| D_{1.2} | D_{1.1} | D |
|---|---|---|
| 0 | 0 | 0 |
| 0 | 1 | 6.25% |
| 1 | 0 | 12.5% |
| 1 | 1 | 25% |

Default value of {D_{1.2}, D_{1.1}} is {l 0} which means D=12.5%. D₀ is used for testing neighbors in the same color plane.

| | |
|---|---|
| Values of D₀: | 1 → 12.5% |
| | 0 → 6.25% |
| Default value of D₀: | 1 |

“EnMem” is used to have more information available from the previous line to avoid a correction of a very thin line.

| Values of “EnMem”: | 1 → use previous line information |
|---|---|
| | 0 → do not use previous line information |
| Default value of “EnMem”: | 1 |

“EnCor” is used to enable or disable the pixel correction

| Values of “EnCOR”: | 1 → use correction algorithm |
|---|---|
| | 0 → do not use correction algorithm |
| Default value of “EnCOR”: | 1 |

“Cor_avg” is used to indicate the way a pixel is to be corrected.

| Values of “Cor_avg”: | 1 → use average of neighbors |
|---|---|
| | 0 → use largest neighbors |
| Default value of “Cor_avg”: | 1 |

In summary a real-time pixel correction algorithm has been proposed for on-the-fly repair of pixel information from dead or disturbed pixels from a pixel array, referred an be used for both CCD and CMOS

List of Reference Numbers

1 stack
2 black offset register level (BOR), user-programmed
3 threshold=maximum value of noise level
4 pseudo variance
   σ=threshold-BOR=distribution of noise
5 leaker
6 pixel number
7 pixel name
8 pixel under test
9 Gᵢ—pixel assigned to green color
10 Rᵢ—pixel assigned to red color
A′ meaning test
B′ neighbor test of the same color plane
C′ neighbor test of a different color plane
C′₋₁, C′₁ nearest-neighbor-comparison
C′₋₃, C′₃ second-nearest-neighbor-comparison
D′ correlation test

1. Method of detection of erroneous image sample data of defective image samples from a plurality of image sample data comprising a first number of image sample data assigned to a first color and at least a second number of image sample data assigned to a second color, wherein an image sample data under test is tested with respect to further image sample data and
a first kind of test is performed with respect to a further image sample data assigned to the same color as that to which the image sample data under test is assigned; and
a second kind of test is performed with respect to still a further image sample data assigned to a different color than that to which the image sample data under test is assigned.

2. Method as claimed in claim 1, characterized in that an image sample data comprises a value of a pixel corresponding to an image sample.

3. Method as claimed in one of the preceding claims, characterized in that a comparison of the image sample data under test with regard to a threshold value is made, in particular a comparison with a maximum value of noise level.

4. Method as claimed in claim 1, characterized in that a first or second kind of test is based on a maximum value (max) comparison.

5. Method as claimed in one of the preceding claims, characterized in that image sample data are arranged in a stack from which an offset, a threshold and a variance of image sample data are defined.

6. Method as claimed in claim 3, characterized in that the threshold is defined as the sum of the variance and the offset.

7. Method as claimed in claim 5 or 6, characterized in that a test comprises a comparison of a difference-value of at least two image sample data with respect to the variance.

8. Method as claimed in any of the claims 5 to 7, characterized in that various variance values are defined for the variance with respect to a variety of modes, in particular a first variance value with respect to a snapshot mode and a second variance value with respect to a video mode.

9. Method as claimed in one of the preceding claims, characterized in that a first or second kind of test takes into consideration a noise level correction.

10. Method as claimed in one of the preceding claims, characterized in that a first or second test is essentially based on neighbor-comparison in a one-dimensional array or a two-dimensional array of image sample data.

11. Method as claimed in claims 1 to 10, characterized in that still further second kind of tests comprise at least one test selected from the group consisting of: nearest-neighbor-comparison, second-nearest-neighbor-comparison, further-neighbor-comparison.

12. Method as claimed in one of the preceding claims, characterized in that a plausibility test is performed as a third kind of test, in particular a plausibility test taking into consideration previous and/or following tests.

13. Method as claimed in one of the preceding claims, characterized by real-time-performance, in particular the prevention of the use of a defect-memory.

14. Method as claimed in one of the preceding claims, characterized in that a color parameter is applied to discriminate between a test with respect to image sample data assigned to the same color and a test with respect to image sample data assigned to different colors.

15. Method of image processing wherein
an image is provided by an optical system to an image color sensor adapted to detect various colors, in particular red, green or blue, and sensor the image as a plurality of image samples, and wherein
image sample data are read out from each single image sample of the image sensor and the image sample data comprise color information, in particular color information of red, green or blue,
the image sample data are transferred in an image signal from the image sensor to a signal processor, and
the signal processor derives a video output from the image signal, wherein erroneous image sample data of defective image samples are detected and corrected from the plurality of image sample data wherein
image sample data is tested to thereby detect erroneous image sample data and erroneous image sample data is corrected by replacing erroneous image sample data by corrected image sample data,
characterized in that
the plurality of image sample data comprise a first number of image sample data assigned to a first color and at least a second number of image sample data assigned to a second color, and wherein
for image sample data under test the detection comprises the steps of:
comparing the image sample data under test to a threshold value,
performing a first kind of test with respect to further image sample data assigned to the same color as that to which the image sample data under test is assigned,
performing a second kind of test with respect to still a further image sample data assigned to a different color than that to which the image sample data under test is assigned,
performing a plausibility test as a third kind of test, taking into consideration a previous and/or following test of still further image sample data.

16. Method as claimed in the preceding claim characterized in that for detection and correction a shift register, a threshold calculation and a memory are provided.

17. Method as claimed in claim 15 or 16 characterized in that the correction comprises an interpolation.

18. Method as claimed in claim 16 characterized in that a one-bit-line-memory or a two-bit-line-memory is provided.

19. Method as claimed in claim 15 characterized in that the read-out from the image sensor is a serial read-out.

20. Processor device for deriving a video output from an image signal comprising a memory and a processing unit and an interface connectable to a photoelectric image sensor and to a monitor, which is adapted to execute a method of detection as claimed in any one of the claims 1 to 14.

21. Imager system comprising an optical system, a photoelectric image sensor and a processor device adapted to implement a method of image processing as claimed in anyone of the claims 15 to 20.

22. Imager system as claimed in claim 21 wherein the photoelectric image sensor is formed by a sensor selected from the group consisting of:
a CMOS-imager, a CCD-imager, a charge-transfer imager, a charge injection device, a bucket-brigade imager and a RGB-Bayer image sensor.

23. Program product for a computing system or a processor device, which can be stored on a medium and can be read out by the computing system or processor device, comprising a software code section, which induces the computing system or processor device to execute the method of detection as claimed in any one of the claims 1 to 20 when the product is executed on the computing system or processor device, in particular when executed on a processor device of claim 21 or on an image system as claimed in any one of the claims 22 or 23.
